(19) United States
(12) Patent Application Publication
(10) Pub. No.: US 2025/0117774 A1
(43) Pub. Date: Apr. 10, 2025

(54) Electronic Devices and Corresponding Methods for Presenting Potential Processor System Failure Mode Notifications

(71) Applicant: Motorola Mobility LLC, Chicago, IL (US)

(72) Inventors: Amit Kumar Agrawal, Banaglore (IN); Krishnan Raghavan, Bangalore (IN); Hariprasad Shanbhogue Alampady, Bangalore (IN)

(21) Appl. No.: 18/377,780

(22) Filed: Oct. 7, 2023

(51) Int. Cl. G06Q 20/32; G06F 9/54; G06Q 10/1093; G06Q 20/36; H04W 4/029

(52) U.S. Cl. CPC G06Q 20/3263; G06F 9/542; G06Q 10/1095; G06Q 20/36; H04W 4/029

(57) ABSTRACT

An electronic device includes a user interface, a communication device, and one or more processors operable with the user interface and communication device and operating a digital wallet application. The one or more processors are configured to determine a probable failure of the digital wallet application to complete upcoming financial transactions due to one or more merchant or payment processor system malfunctions and cause the user interface to present a potential payment failure mode notification identifying the one or more merchant or payment processor system malfunctions prior to the upcoming financial transactions occurring.

### BACKGROUND

### Technical Field

This disclosure relates generally to electronic devices, and more particularly to electronic devices having user interfaces.

### Background Art

Portable electronic devices, such as smartphones and tablet computers, are now the primary electronic tools with which people communicate, engage in commerce, maintain calendars and itineraries, monitor health, capture images and video, and surf the Internet. In many instances, a person is more likely to carry a smartphone than a watch or wallet. Indeed, with the advent of personal finance, banking, and shopping applications many people can transact personal business solely using a smartphone and without the need for cash or a physical credit card.

While such technology is incredibly convenient, it, like all technology, can have operational issues. It would be advantageous to have improved devices and systems to address such operational issues.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory method in accordance with one or more embodiments of the disclosure.

FIG. 2 illustrates one explanatory electronic device in accordance with one or more embodiments of the disclosure.

FIG. 3 illustrates another explanatory method in accordance with one or more embodiments of the disclosure.

FIG. 4 illustrates one or more method steps in accordance with one or more embodiments of the disclosure.

FIG. 5 illustrates one or more method steps in accordance with one or more embodiments of the disclosure.

FIG. 6 illustrates one or more method steps in accordance with one or more embodiments of the disclosure.

FIG. 7 illustrates one or more method steps in accordance with one or more embodiments of the disclosure.

FIG. 8 illustrates one or more embodiments of the disclosure.

FIG. 9 illustrates a prior art method.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to identifying, with one or more processors of an electronic device from data retrieved with a communication device, one or more probable digital wallet application payment failure modes due to one or more merchant or payment processor system malfunctions and, in response, presenting a potential payment failure mode notification on a user interface of the electronic device that identifies the at least one probable digital wallet payment failure mode.

Any process descriptions or blocks in flow charts should be understood as representing modules, segments, or portions of code which include one or more executable instructions for implementing specific logical functions or steps in the process. Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of utilizing one or more processors to determine a probable failure of a digital wallet application to complete upcoming financial transactions due to one or more merchant or payment processor system malfunctions and cause a user interface to present a potential payment failure mode notification identifying a reason for the probable failure of the digital wallet application to complete the upcoming financial transactions prior to the upcoming financial transactions occurring as described herein. The non-processor circuits may include, but are not limited to, a radio receiver, a radio transmitter, signal drivers, clock circuits, power source circuits, and user input devices.

As such, these functions may be interpreted as steps of a method to perform detecting an expected future financial transaction with a merchant requiring on-site payment, retrieving reasons indicating that completion of the expected future financial transaction using a digital wallet application operating on the one or more processors will be unsuccessful due to one or more merchant or payment processor system malfunctions, and presenting a potential payment failure mode notification identifying one or more embodiments alternate modes of payment that will be successful in completing the expected future financial transaction due to one or more merchant or payment processor system malfunctions and explaining the reasons indicating that the completion of the expected future financial transaction using the digital wallet application operating on the one or more processors will be unsuccessful due to one or more merchant or payment processor system malfunctions. Alternatively, some or all functions could be implemented by a state machine that has no stored program instructions, or in one or more application specific integrated circuits (ASICs), in which each function or some combinations of certain of the functions are implemented as custom logic.

Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent. The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

Embodiments of the disclosure provide methods, electronic devices, and systems that alert users to situations where a digital wallet application operating on one or more processors of the electronic device may not be operational to process expected future financial transactions due to one or more merchant or payment processor system malfunctions. In one or more embodiments, when this occurs the one or more processors can present a potential payment failure mode notification identifying one or more failure modes resulting in the digital wallet application being unable to process the expected future financial transaction before the expected future financial transaction occurs.

In one or more embodiments, a method in an electronic device comprises detecting, with one or more processors of the electronic device, a prospective financial transaction using a digital wallet application operable on the one or more processors of the electronic device. The method also includes identifying, with the one or more processors from data retrieved with a communication device of the electronic device, one or more probable digital wallet application payment failure modes due to one or more merchant or payment processor system malfunctions and, in response to identifying at least one probable digital wallet application payment failure mode, presenting by the one or more processors on a user interface of the electronic device a potential payment failure mode notification identifying the at least one probable digital wallet application payment failure mode.

Advantageously, embodiments of the disclosure pre-emptively warn users when there may be issues with a bank server, electronic banking accounts, or with a payor's or payee's electronic device. This prevents users from being embarrassed by being unable to pay for a product or service that has already been consumed when merchant or payment processor issues arise, despite the fact that such issues are not the payor's fault.

Embodiments of the disclosure contemplate that many modern electronic devices include both financial applications and shopping applications. Illustrating by example, Motorola Mobility has launched a banking application called DIMO.sup.TM in Brazil. This, as well as other, banking applications are redefining the way that banking occurs. Rather than having to go to a bank to physically talk to a teller during business hours to complete a financial transaction, banking applications offer “24-7” banking with instantaneous transfers of money. Banking can be done exclusively using a smartphone. Even automated teller machine (ATM) withdrawals can be made using only a smartphone.

The advent of applications such as DIMO.sup.TM are leading to users simply ceasing to carry paper currency or coins. Moreover, applications like DIMO.sup.TM have caused people to stop carrying physical credit and debit cards as well since the credit and debit card account information can simply be loaded into a smartphone, with near-field and other communication devices allowing direct transactions of money electronically.

Embodiments of the disclosure also contemplate that issues can arise with digital wallet applications and other financial applications and e-commerce applications. Embodiments of the disclosure contemplate that sometimes, with advancing technology, convenience and ne complications can go hand in hand. When such issues arise in conjunction with the use of a digital wallet application, users can find themselves suddenly in troubling or unpleasant situations when the time to pay for a particular good or service arises. This can be especially frustrating when the issues are due to one or more merchant or payment processor system malfunctions that are not the fault of the digital wallet holder. Illustrating by example, if the payee's system is experiencing a planned or unplanned outage or their point of sale device is damaged or broken, this can render a payor's digital wallet application to be inoperative. Despite this not being the payor's fault, embarrassment and humiliation can still result when they do not have another payment mode on hand.

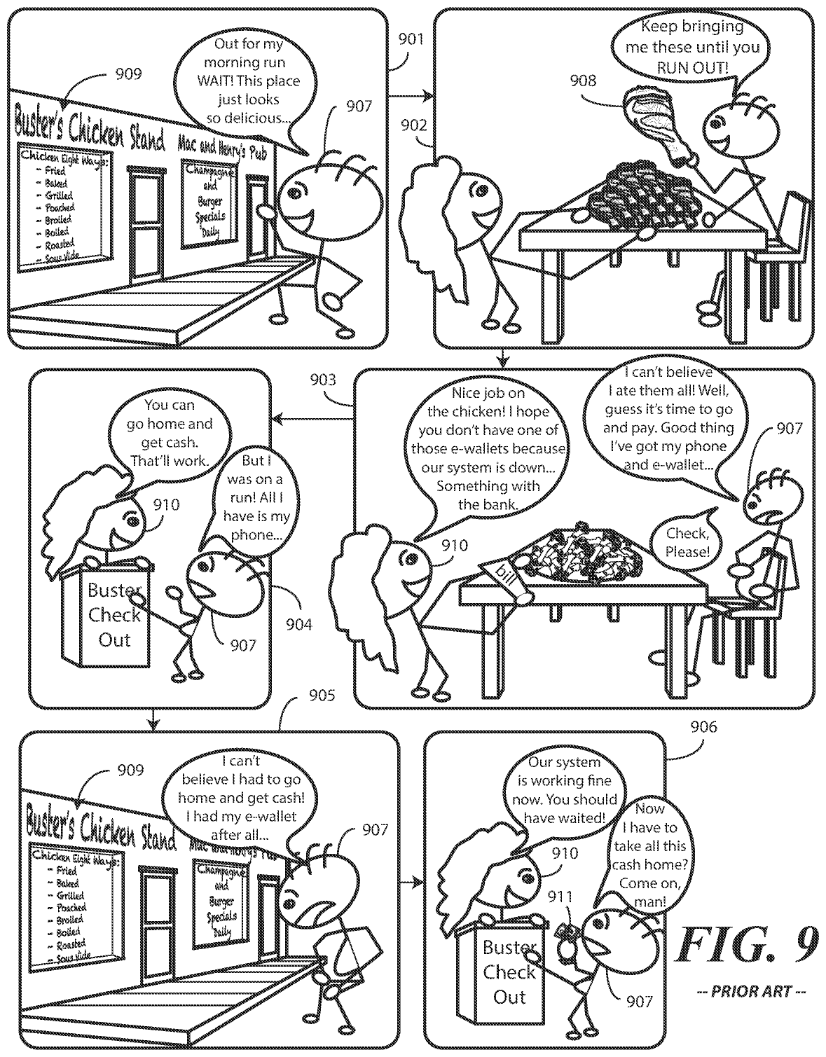

Turning briefly to FIG. 9, illustrated therein are one or more prior art method steps demonstrating how this can occur. Beginning at step 901, Paul 907 is finishing his usual Sunday morning run when he comes across the world famous Buster's Chicken Stand 909. Buster's Chicken Stand 909 is universally renowned for some of its exceptionally good chicken 908, which is served eight different ways. Buster's Chicken Stand 909 just happens to be located next to the equally famous Mac and Henry's Pub, where Champagne and burgers are served daily as a local favorite specialty.

At step 902, Paul 907 gets to actually try the chicken 908 for the first time in his life. Having a true epiphany, he cannot believe that he has been missing out on this local delicacy for so long. Determined to make up for lost time, Paul 907 tells the kind waitstaff 910 to keep bringing the chicken “until you run OUT!”

At step 903, having finished his tenth platter of chicken, leaving nothing but bones in the “cemeteria” on the table, Paul 907 is stuffed. While this will be a large tab, Paul 907 regrets nothing as this has been a truly life-changing experience. Since paying this tab would require a lot of cash (Paul 907 ate a lot of chicken 908, after all), Paul 907 is really glad to have his smartphone with its digital wallet application operating on the one or more processors of the smartphone. Using the digital wallet application, transferring a lot of money only takes a few clicks. Plus, the chances of Paul 907 getting mugged in his post-chicken stupor since he need not carry large piles of cash in his pocket during his run.

There is a problem, however. As shown at step 903, the friendly waitstaff 910 informs Paul 907 that digital payment methods are failing that day due to an issue on their bank side. With his smartphone out of service, Paul 907 is in a real pickle. At step 904, Paul 907 explains to the friendly waitstaff 910 that he only carries his smartphone these days to make payments because he does not want to be mugged in the streets from carrying large piles of cash. Unmoved, the friendly waitstaff 910 tells Paul 907 to take exactly that risk, namely, to go home and get a pile of cash. After all, Paul 907 ate a lot of chicken 908 and the tab is quite large.

At step 905, after leaving the restaurant to get cash, Paul 907 is frustrated and demoralized. He paid a lot of money for his smartphone and loves the digital wallet application. After all, the fact that the merchant was having problems on their side was not his fault! And he could have been mugged carrying around this large pile of cash. In any event, Paul 907 is finally glad to be back at Buster's Chicken Shack 909 to finally settle the debt.

Adding salt to the wound, at step 906 when Paul 907 tries to pay the bill with his large wad of cash 911 the friendly waitstaff 910 explains that digital payments have started working again and he no longer needs the wad of cash 911. As Paul 907 leaves Buster's Chicken Shack 909, he wonders why he had to make a second trip when he had a perfectly good smartphone and digital wallet.

While embodiments of the disclosure contemplate that a digital wallet application can be inoperable for any number of reasons, frequently the inability of a digital wallet application to complete a financial transaction can be attributed to unfavorable circumstances on the payee's side. Reasons can include issues with a payee's banking servers, such as a planned bank outage or an unplanned bank outage.

There can also be issues with a merchant's point of sale system. It may be broken or otherwise inoperable. Their Internet service can be down as well, preventing a digital wallet application from being able to execute financial transactions with the merchant. This may be the case when the payee is experiencing poor network connectivity, for example. The payee's device may have a broken display or other failing components. Moreover, the payee's point of sale device may be inadvertently locked due to security reasons resulting in the operator being unable to unlock the corresponding device.

Embodiments of the disclosure provide a solution to this madness by providing contextually relevant alerts that let a person know when an expected future financial transaction using a digital wallet application operating on one or more processors of an electronic device likely will be unsuccessful due to one or more merchant or payment processor system malfunctions. In one or more embodiments, the one or more processors of the electronic device do this by presenting a potential payment failure mode notification on a user interface of the electronic device identifying one or more alternate modes of payment that will be successful in completing the expected future financial transaction. In one or more embodiments, the potential payment failure mode notification also explains the reasons indicating that completion of the expected future financial transaction using the digital wallet application will be unsuccessful due to one or more merchant or payment processor system malfunctions. In poor Paul's case, the potential payment failure mode notification would have explained that Buster's Chicken Shack was temporarily unable to execute financial transactions using digital wallet applications.

In one or more embodiments, an electronic device comprises a user interface, a communication device, and one or more processors operable with the user interface and the communication device. In one or more embodiments, the one or more processors operate a digital wallet application. In one or more embodiments, the one or more processors are configured to determine a probable failure of the digital wallet application to complete an upcoming financial transaction due to one or more merchant or payment processor system malfunctions. In one or more embodiments, the one or more processors cause the user interface to present a potential payment failure mode notification identifying a reason for the probable failure of the digital wallet application to complete the upcoming financial transaction due to one or more merchant or payment processor system malfunctions prior to the upcoming financial transaction occurring.

Advantageously, embodiments of the disclosure allow a user of the electronic device to make alternate arrangements for making payment to a merchant on-site when the merchant or its payment processor is experiencing technical difficulties with their equipment, network, software, or combinations thereof. This helps to prevent not only embarrassment but also the loss of time and benefits when engaging in a financial transaction. Consider some examples:

Imagine Anita has a last minute purchase to make for an event coming early the next morning. Imagine that Anita starts her meticulous search in a store a couple of miles away. By the times she decides what to buy, it has become quite late.

As the clerk prints the bill, Anita takes out her smartphone. Since it has a digital wallet application, she plans to make payment using the smartphone. Unfortunately, the clerk politely lets her know that the transaction fails due to the fact that a rogue hooligan just entered the store and took the e-commerce terminal right off the desk.

Downtrodden, Anita leaves the store without her purchase because she does not have enough cash on hand to complete the purchase. And this was not even her fault! The prospect of not having her last minute purchase for her upcoming event become very real. She cannot stop wondering how she could have avoided the situation, and even feels anger at both the merchant and the hooligan.

Advantageously, embodiments of the disclosure prevent such situations from happening. In one or more embodiments, a method in an electronic device comprises detecting, by one or more processors, an expected future financial transaction with a merchant requiring an on-site payment due to one or more merchant or payment processor system malfunctions. A communication device of the electronic device retrieves reasons indicating that completion of the expected future financial transaction using a digital wallet application operating on the one or more processors will be unsuccessful due to one or more merchant or payment processor system malfunctions. The one or more processors then present, on a user interface of the electronic device, a potential payment failure mode notification identifying one or more alternate modes of payment that should be successful in completing the expected future financial transaction.

Optionally, the potential payment failure mode notification can explain reasons indicating that completion of the expected future financial transaction using the digital wallet application operating on the one or more processors will be unsuccessful due to one or more merchant or payment processor system malfunctions.

Poor Anita! If she only had an electronic device configured in accordance with one or more embodiments of the disclosure, she would have received a potential payment failure mode notification indicating that the merchant's point of sale system had been ripped from the wall by the rogue hooligan. En route to this last store, she would have been able to stop by an automated teller machine for some quick cash to complete that final financial transaction since the merchant had no way to process a digital wallet application transaction.

Advantageously, embodiments of the disclosure would have saved Anita all of this frustration. In one or more embodiments, one or more processors of an electronic device predict payments that a user is expected to make using a digital wallet application. This determination can be made in a variety of ways, one example of which including accessing a set of past payments or spending patterns, each of which could be associated with a particular time, location, or other metadata. In another example, the one or more processors can access one or more calendar events from a calendaring application operating on the one or more processors to determine whether expected future financial transactions are noted in those calendar events. The one or more processors can also access to-do lists and to-do list items to determine whether any expected future financial transactions are indicated in the same.

Thereafter, in one or more embodiments the one or more processors evaluate probable payment failures by fetching an analyzing available information via various communications parsed on the payor device. The one or more processors can do this by accessing alert messages from banking servers, past failures at specific locations and/or times, planned outages at merchant locations. If the payee is not a formal merchant, but is instead an individual or sole proprietor, the one or more processors can determine that the payee wallet has reached a maximum limit for transactions for the day and is unable to receive any additional amounts.

Regardless of payee size, embodiments of the disclosure also contemplate that the payee's wallet may be blocked by a bank for a variety of reasons as well, examples of which include a lack of paperwork, a lack orientation detector documentation, expiration of the business account and so forth. In one or more embodiments, one or more processors of the payor's electronic device determine that these situations have occurred by retrieving data from a remote electronic device related to the payee across a network. If the point of sale terminal is broken—or stolen as in Anita's case—the one or more processors of the payor device can determine this from data retrieved from a remote electronic device across a network. The same can occur if the network coverage is subpar or down at the payee location. Other data that the one or more processors can access to evaluate probably failures will be obvious to those of ordinary skill in the art having the benefit of this disclosure.

In one or more embodiments, the one or more processors can then alert he user if the evaluation indicates a probable failure due to one or more merchant or payment processor system malfunctions. Such alert messages can include predicted payment events for which payment could fail and the associated reason the merchant or payment processor is unable to complete the predicted payment electronically. Such alert messages can also include messages indicating potential actions that a user can take such as asking the user to carry alternative payment methods, delaying the payment, and so forth.

In one or more embodiments, the alerts are delivered at particular times of day. Illustrating by example, in one or more embodiments the alerts could be delivered at the start of the day. In still other embodiments, the alerts could be delivered when the user leaves their home location defined by their place of residence.

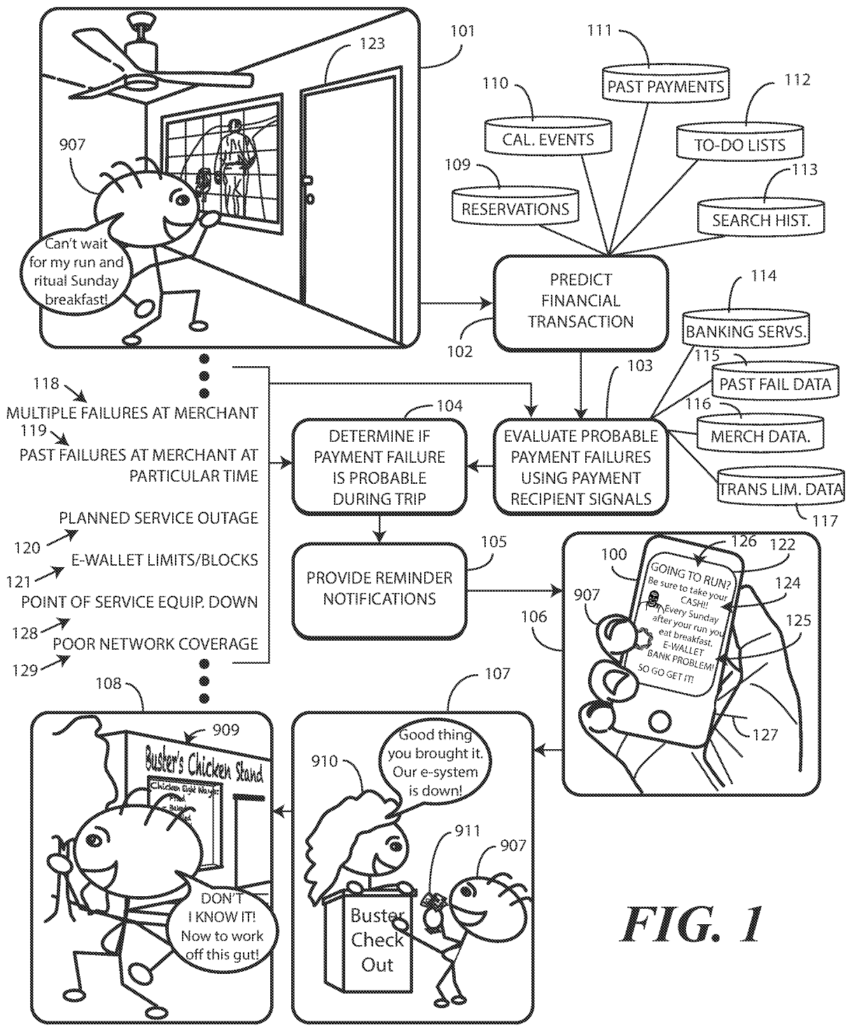

Turning now to FIG. 1, illustrated therein are one or more method steps depicting how the dreadful situation illustrated in FIG. 9 can be avoided using embodiments of the disclosure. FIG. 1 begins with Paul 907 leaving his residence 123 to go on his Sunday morning run, which he plans to follow with a nice breakfast.

At step 102, one or more processors of his electronic device 100 (shown as a smartphone at step 106) detect a prospective financial transaction using a digital wallet application operable on one or more processors of the electronic device 100. This can be done in a variety of ways.

Illustrating by example, one or more processors of the electronic device 100 can query a database of reservations 109 made using the electronic device 100 with a merchant, examples of which include the gym, a restaurant, a hospital, chicken shack, or a recreational service provider. Thus, in one or more embodiments detection of the prospective financial transaction using the digital wallet application comprises receiving, with the communication device by the one or more processors, an electronic communication identifying both a scheduled appointment and a merchant that is stored in the database of reservations 109 made using the electronic device 100 with the merchant.

In other embodiments, detection of the prospective financial transaction using the digital wallet application comprises querying, by the one or more processors, a calendaring application to detect a scheduled appointment from one or more calendar events 110 stored in the calendaring application that identifies a merchant. Illustrating by example, in this illustrative embodiment Paul 907 set a reminder in a database of calendar events 110 used by a calendaring application operating on the one or more processors of the electronic device 100 that he plans to engage in eating breakfast out of the residence 123 after his run. Accordingly, the one or more processors have queried this database of calendar events 110 to detect that a prospective financial transaction with a restaurant is likely to occur.

In other embodiments, the one or more processors of the electronic device 100 can query a database of past financial transactions 111 to detect an expected future financial transaction. Embodiments of the disclosure contemplate that many electronic wallet programs will maintain such a database of past financial transactions 111, including those associated with a particular time the financial transaction occurred or a particular location in which the financial transaction transpired. In one or more embodiments, the one or more processors of the electronic device 100 detect the prospective financial transaction using the digital wallet application by querying this database of past financial transactions 111.

In one or more embodiments, this querying operation can be triggered, for example, when a particular time that a past financial transaction occurred is occurring during the day or when a location detector of the electronic device 100 determines that the electronic device 100 is at a location where a past financial transaction occurred. Other techniques for triggering the query of this database or the others will be obvious to those of ordinary skill in the art having the benefit of this disclosure.

In one or more embodiments, detection of the prospective financial transaction using the digital wallet application at step 102 comprises querying, from a memory of the electronic device 100 by the one or more processors, past financial transactions 111 made by an authorized user of the electronic device 100 that are stored in the memory and determining, by the one or more processors, a repeating pattern of one or more repeating financial transactions. When such a repeating pattern is found, the one or more processors can predict another instance of the repeating pattern as the prospective financial transaction.

In still another embodiment, the one or more processors of the electronic device 100 can detect the prospective financial transaction with the merchant by querying an electronic to-do list 112 stored in a memory of the electronic device 100. Illustrating by example, rather than setting a reminder in the calendaring application, Paul 907 may have created an electronic to-do entry in an electronic to-do list 112 stored in a memory of the electronic device 100 that says, “Treat Yourself to a Nice Breakfast as a Reward for Your Sunday Run!”

Accordingly, the one or more processors of the electronic device 100 may detect the prospective financial transaction using the digital wallet application by retrieving this electronic to-do entry from the electronic to-do list 112. Thus, in one or more embodiments detection of the prospective financial transaction using the digital wallet application comprises querying, by the one or more processors form a memory of the electronic device 100, an electronically stored to-do list 112 to identify one or more to-do items stored in the memory that reference a merchant.

In still other embodiments, the one or more processors can detect the prospective financial transaction using the digital wallet application by examining a past search history 113 of an Internet browser application. If Paul 907 had been trying to decide where the most critically acclaimed restaurant suitable for breakfast after his run (obviously Buster's Chicken Shack 909) was located, he may have searched using an Internet browser application. After spending more time on the Buster's Chicken Shack website than that of the Mac and Henry's Pub, the one or more processors of the electronic device 100 may have detected a prospective financial transaction with Buster's Chicken Shack 909. Thus, in one or more embodiments the detection of the prospective financial transaction using the digital wallet application at step 102 comprises querying, by the one or more processors from a memory of the electronic device 100, an Internet search history 113 of a web browsing application stored in the memory to identify a search history entry identifying a merchant.

These examples of how one or more processors of an electronic device 100 can detect a prospective financial transaction with a merchant using a digital wallet application. Others will be described below. Still others will be obvious to those of ordinary skill in the art having the benefit of this disclosure.

At step 103, the one or more processors identify, from data retrieved with a communication device of the electronic device 100, one or more probable digital wallet application payment failure modes due to one or more merchant or payment processor system malfunctions. At optional step 104, the one or more processors determine whether the one or more probable digital wallet application payment failure modes due to one or more merchant or payment processor system malfunctions are likely to occur while Paul 907 away from his residence 123. Illustrating by example, step 104 may determine whether the one or more probable digital wallet application payment failure mode will occur during the expected time Paul 907 will be away from the residence 123. As with detecting the prospective financial transaction using the digital wallet application, these steps 103,104 can occur in a variety of ways.

In one or more embodiments, the one or more processors of the electronic device 100 retrieve data from banking servers 114 operable with the digital wallet application. This data can include planned or unplanned outages of a digital wallet application service, a maximum number of transactions a payee can receive across a predetermined time, a maximum transaction amount a payee can receive from a digital wallet application, a cumulative maximum transaction amount allowed for a payee during a predetermined time duration, or other information. It can also include planned maintenance for networks and systems. Indeed, in one or more embodiments the data retrieved with the communication device of the electronic device 100 at step 103 comprises one or more alert messages from one or more payment method purveyors or payment mode processors, one example of which includes the banking servers 114, indicating that one or more merchant or payment processor system malfunctions may be occurring.

Similarly, the one or more processors of the electronic device 100 can retrieve data from past digital wallet application failure mode databases. In one or more embodiments, the one or more processors cause the communication device to retrieve data comprising a plurality of past financial transactions 115 made due to one or more merchant or payment processor system malfunctions that are stored in the memory of the electronic device 100, and that define a repeating pattern of one or more repeating financial transactions where issues with a merchant or payment processor on the merchant's side rendered a digital wallet application unavailable for use. As with the past financial transactions 111, this repeating pattern can be used to predict another instance of the repeating pattern where the digital wallet application will be unavailable for use due to one or more merchant or payment processor system malfunctions.

In still other embodiments, the one or more processors of the electronic device 100 cause the communication device to retrieve data from one or merchant databases 116. In one or more embodiments, these data are swept from a website belonging to the merchant. When the merchant's e-commerce systems are down, the merchant may post a notice on the website. In one or more embodiments, the one or more processors of the electronic device 100 can sweep this data to determine a probable failure due to one or more merchant or payment processor system malfunctions.

In still other embodiments, the one or more processors identify the one or more probable digital wallet application payment failure modes at step 103 by retrieving data from transaction limitation databases 117, examples of which may be operated by a payment method purveyor or payment mode processor. In one or more embodiments, these data comprise limitations 121 associated with a merchant. These limitations 121 can comprise one or more of a predefined transaction limit defined by a payment method purveyor or payment mode processor for that merchant and/or a predefined maximum transaction defined by the payment method purveyor or the payment mode processor for the merchant. The limitations can be due to the merchant failing to complete required paperwork, failure of the merchant to submit required documentation, failure of the merchant to renew a bank account resulting in its expiry, or other reasons. Still other examples of such limitations 121 will be obvious to those of ordinary skill in the art having the benefit of this disclosure.

Thus, in one or more embodiments step 103, and optionally step 104, can be performed when the one or more processors of the electronic device 100 fetch and analyze data from a remote electronic device over a network. Said differently, in one or more embodiments step 103 and/or step 104 comprise retrieving, with a communication device of the electronic device 100, data indicating that one or more digital wallet application failure modes due to one or more merchant or payment processor system malfunctions is likely, optionally during a predefine time that a person will be away from their residence 123, from a remote electronic device across a network.

Examples of probable failure modes that may indicate that a digital wallet application will be unsuccessful in completing an expected future financial transaction with a merchant due to one or more merchant or payment processor system malfunctions shown in FIG. 1 include multiple failures 118 at the business within a given time period, past failures 119 at the payee within a given time, planned outages 120 of the payee banking service, limitations 121 on the amount of money a payee wallet can receive, service disruptions 128 associated with equipment at the payee's location (this information sure would have saved Anita!), and problems 129 with network coverage at the payee's location. This list is illustrative only, as other probable failure modes will be obvious to those of ordinary skill in the art having the benefit of this disclosure.

In one or more embodiments, this data comprises data available with the payment processor or payment gateway that a connecting banking server uses to process financial transactions with the merchant. In other embodiments, this data comprises data that is publicly available. Illustrating by example, the data that is publicly available may be obtained by accessing a website operated by the bank supporting the digital wallet application as noted above, and so forth.

In one or more embodiments, at step 105, in response to identifying at least one probable digital wallet application payment failure mode due to one or more merchant or payment processor system malfunctions at step 103, optionally likely to occur while Paul 907 is away from his residence 123 as determined at step 104, step 105 comprises presenting, by the one or more processors on a user interface of the electronic device 100, a potential payment failure mode notification 122 identifying the at least one probable digital wallet application payment failure mode due to one or more merchant or payment processor system malfunctions. One example of such a potential payment failure mode notification 122 is shown at step 106.

In one or more embodiments, the potential payment failure mode notification 122 comprises at least one alternate payment mode suggestion 124. Recall from the example set forth in FIG. 9 that the merchant's banking system was under maintenance while Paul 907 was eating all that chicken. Accordingly, since the digital wallet application would be unavailable for use due to one or more merchant or payment processor system malfunctions, the alternate payment mode suggestion comprises a payment mode, here the use of a wad of cash 911, that omits the use of the digital wallet application.

In one or more embodiments, the potential payment failure mode notification 122 also identifies the one or more merchant or payment processor system malfunctions 125. In this illustrative example, the one or more merchant or payment processor system malfunctions 125 for the at least one probable digital wallet application payment failure mode is that there is a problem with the payee's bank. Other examples of reasons that a digital wallet application may be unable to complete an expected future financial transaction due to one or more merchant or payment processor system malfunctions will be obvious to those of ordinary skill in the art having the benefit of this disclosure.

Embodiments of the disclosure contemplate that it can be advantageous to present the potential payment failure mode notification 122 at particular times of day. Illustrating by example, in one or more embodiments the potential payment failure mode notification 122 is presented at a particular time of day 126, such as the time when Paul 907 is leaving his residence 123 to go on a run. The time of day 126 could be alternatively determined from an alarm clock application operating on the one or more processors of the electronic device 100 or from a first scheduled event in a calendaring application operating on the one or more processors of the electronic device 100. In other embodiments, the potential payment failure mode notification 122 can be presented on the user interface when a location detector of the electronic device 100 determines that Paul 907 is leaving a particular location, one example of which is his residence 123. Other examples of times when the offered payment mode notification can be presented will be obvious to those of ordinary skill in the art having the benefit of this disclosure.

As shown at step 105, in this illustrative embodiment the potential payment failure mode notification 122 presented on the user interface of the electronic device 100 asks Paul 907, “Going to Run?” The potential payment failure mode notification 122 then includes a reminder to take a wad of cash 911, as the electronic payment system of the merchant's bank will be under maintenance during this time duration. To show that the potential payment failure mode notification 122 is urgent and should not be ignored, the potential payment failure mode notification 122 includes a reminder to “go get it” for emphasis.

As noted above, in one or more embodiments this offered potential payment failure mode notification 122 is presented at a predetermined time during the day. In this illustrative embodiment, the predetermined time during the day occurs when a location detector detects Paul 907, an authorized user of the electronic device 100, exiting his dwelling. In this illustrative embodiment, the potential payment failure mode notification 122 is presented in conjunction with an audio output device of the electronic device 100 delivering an audible alert 127 concurrently therewith.

At step 107, Paul 907 again goes to pay his bill after the massive chicken breakfast at Buster's Chicken Stand 909. Since Paul's electronic device 100 is configured in accordance with embodiments of the disclosure, he has his wad of cash 911 in hand, ready to pay. The friendly waitstaff 910, incredibly impressed with Paul's foresight, is thrilled, letting him know that the payment system operable with the digital wallet application is indeed under maintenance. At step 108, he is elated that his smartphone predicted this probable failure of the digital wallet application due to one or more merchant or payment processor system malfunctions prior to the upcoming financial transaction with Buster's Chicken Stand 909 occurring so he could run home, lose the chicken fat, and take a long nap.

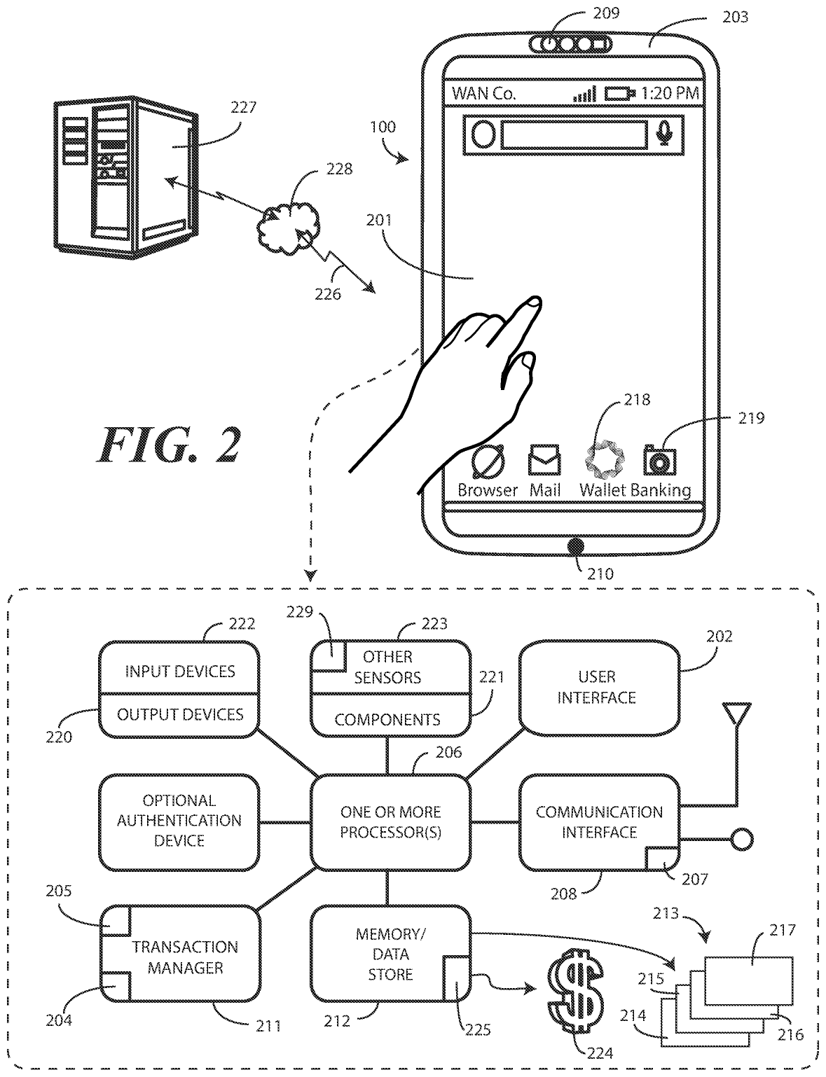

Turning now to FIG. 2, illustrated therein is one electronic device 100 configured in accordance with one or more embodiments of the disclosure. The electronic device 100 of this illustrative embodiment includes a user interface 202. In one or more embodiments, the user interface 202 comprises a display 201, which may optionally be touch-sensitive. The display 201 can serve as a primary user interface 202 of the electronic device 100.

Where the display 201 is touch sensitive, users can deliver user input to the display 201 by delivering touch input from a finger, stylus, or other objects disposed proximately with the display. In one embodiment, the display 201 is configured as an active-matrix organic light emitting diode (AMOLED) display. However, it should be noted that other types of displays, including liquid crystal displays, would be obvious to those of ordinary skill in the art having the benefit of this disclosure.

The explanatory electronic device 100 of FIG. 2 includes a housing 203. Features can be incorporated into the housing 203. Examples of features that can be included along the housing 203 include an imager 209, shown as a camera in FIG. 2, or an optional speaker port. A user interface component 210, which may be a button or touch sensitive surface, can also be disposed along the housing 203.

A block diagram schematic of the electronic device 100 is also shown in FIG. 2. In one embodiment, the electronic device 100 includes one or more processors 206. In one embodiment, the one or more processors 206 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more Application Specific Integrated Circuits (ASICs), programmable logic, or other type of processing device. The application processor and the auxiliary processor(s) can be operable with the various components of the electronic device 100. Each of the application processor and the auxiliary processor(s) can be configured to process and execute executable software code to perform the various functions of the electronic device 100. A storage device, such as memory 212, can optionally store the executable software code used by the one or more processors 206 during operation.

In this illustrative embodiment, the electronic device 100 also includes a communication device 208 that can be configured for wired or wireless communication with one or more other devices or networks. The networks can include a wide area network, a local area network, and/or personal area network. The communication device 208 may also utilize wireless technology for communication, such as, but are not limited to, peer-to-peer, or ad hoc communications such as HomeRF, Bluetooth and IEEE 802.11 based communication, or alternatively via other forms of wireless communication such as infrared technology. The communication device 208 can include wireless communication circuitry, one of a receiver, a transmitter, or transceiver, and one or more antennas.

The electronic device 100 can optionally include a near field communication circuit 207 used to exchange data, power, and electrical signals between the electronic device 100 and another electronic device. In one embodiment, the near field communication circuit 207 is operable with a wireless near field communication transceiver, which is a form of radio-frequency device configured to send and receive radio-frequency data to and from the companion electronic device or other near field communication objects. In one or more embodiments, the near field communication circuit 207 is operable with a digital wallet application 218 to complete financial transactions, provided there are no merchant or payment processor system malfunctions.

Where included, the near field communication circuit 207 can have its own near field communication circuit controller in one or more embodiments to wirelessly communicate with companion electronic devices using various near field communication technologies and protocols. The near field communication circuit 207 can include—as an antenna—a communication coil that is configured for near-field communication at a particular communication frequency.

The term “near-field” as used herein refers generally to a distance of less than about a meter or so. The communication coil communicates by way of a magnetic field emanating from the communication coil when a current is applied to the coil. A communication oscillator applies a current waveform to the coil. The near field communication circuit controller may further modulate the resulting current to transmit and receive data, power, or other communication signals with companion electronic devices.

In one embodiment, the one or more processors 206 can be responsible for performing the primary functions of the electronic device 100. For example, in one embodiment the one or more processors 206 comprise one or more circuits operable to present presentation information, such as images, text, and video, on the display 201. The executable software code used by the one or more processors 206 can be configured as one or more modules 213 that are operable with the one or more processors 206. Such modules 213 can store instructions, control algorithms, and so forth.

In one embodiment, the one or more processors 206 are responsible for running the operating system environment 214. The operating system environment 214 can include a kernel, one or more drivers, and an application service layer 215, and an application layer 216. The operating system environment 214 can be configured as executable code operating on one or more processors or control circuits of the electronic device 100.

The application service layer 215 can be responsible for executing application service modules. The application service modules may support one or more applications 217 or “apps.” Examples of such applications 217 include a cellular telephone application for making voice telephone calls, a web browsing application configured to allow the user to view webpages on the display 201 of the electronic device 100, an electronic mail application configured to send and receive electronic mail, a photo application configured to organize, manage, and present photographs on the display 201 of the electronic device 100, and a camera application for capturing images with the imager 209. Collectively, these applications constitute an “application suite.”

In one or more embodiments, these applications comprise a digital wallet application 218 and/or one or more banking applications 219 that allow financial transactions to be made using the electronic device 100, provided there are no merchant or payment processor system malfunctions. Illustrating by example, in one or more embodiments a user can deliver user input to the digital wallet application 218 or a banking application 219 to initiate a financial transaction initiation communication to complete a financial transaction with a merchant. In one or more embodiments, when this occurs the communication device 208 transmits a financial transaction initiation communication 204 generated by a transaction manager 211.

In one or more embodiments, the transaction manager 211 is operable with the one or more processors 206. In some embodiments, the one or more processors 206 can control the transaction manager 211. In other embodiments, the transaction manager 211 can operate independently, delivering information gleaned from detecting multi-modal social cues, emotional states, moods, and other contextual information to the one or more processors 206. The transaction manager 211 can receive data from the various sensors. In one or more embodiments, the one or more processors 206 are configured to perform the operations of the transaction manager 211.

In one or more embodiments, the one or more processors 206 are responsible for managing the applications and all personal information received from the user interface 202 that is to be used by the digital wallet application 218 and/or banking application 219 after the electronic device 100 is authenticated as a secure electronic device and the user identification credentials have triggered a login event. The one or more processors 206 can also be responsible for launching, monitoring, and killing the various applications and the various application service modules. In one or more embodiments, the one or more processors 206 are operable to not only kill the applications, but also to expunge any and all personal data, data, files, settings, or other configuration tools when the electronic device 100 is reported stolen to wipe the memory 212 clean of any personal data, preferences, or settings of the person previously using the electronic device 100.

The one or more processors 206 can also be operable with other components 221 and other sensors 223. The other components 221, in one embodiment, include input components 222, which can include acoustic detectors as one or more microphones. The one or more processors 206 may process information from the other components 221 alone or in combination with other data, such as the information stored in the memory 212 or information received from the user interface.

Various sensors 223 can be operable with the one or more processors 206 as well. A first example of a sensor that can be included with the sensors 223 is a touch sensor. The touch sensor can include a capacitive touch sensor, an infrared touch sensor, resistive touch sensors, or another touch-sensitive technology. Capacitive touch-sensitive devices include a plurality of capacitive sensors, e.g., electrodes, which are disposed along a substrate. Each capacitive sensor is configured, in conjunction with associated control circuitry, e.g., the one or more processors 206, to detect an object in close proximity with—or touching—the surface of the display 201 or the housing of an electronic device 100 by establishing electric field lines between pairs of capacitive sensors and then detecting perturbations of those field lines.

Another example of a sensor 223 is a geo-locator that serves as a location detector 229. In one embodiment, location detector 229 is able to determine location data by capturing the location data from a constellation of one or more earth orbiting satellites, or from a network of terrestrial base stations to determine an approximate location. Examples of satellite positioning systems suitable for use with embodiments of the present invention include, among others, the Navigation System with Time and Range (NAVSTAR) Global Positioning Systems (GPS) in the United States of America, the Global Orbiting Navigation System (GLONASS) in Russia, and other similar satellite positioning systems. The satellite positioning systems based location fixes of the location detector autonomously or with assistance from terrestrial base stations, for example those associated with a cellular communication network or other ground based network, or as part of a Differential Global Positioning System (DGPS), as is well known by those having ordinary skill in the art. The location detector 229 may also be able to determine location by locating or triangulating terrestrial base stations of a traditional cellular network, such as a CDMA network or GSM network, or from other local area networks, such as Wi-Fi networks.

One or more motion detectors can be included with the sensors 223 and can be configured as an orientation detector that determines an orientation and/or movement of the electronic device 100 in three-dimensional space. Illustrating by example, the motion detectors can include an accelerometer, gyroscopes, or other device to detect device orientation and/or motion of the electronic device 100. Using an accelerometer as an example, an accelerometer can be included to detect motion of the electronic device. Additionally, the accelerometer can be used to sense some of the gestures of the user, such as one talking with their hands, running, or walking.

The motion detectors can determine the spatial orientation and/or motion of the electronic device 100 in three-dimensional space by, for example, detecting a gravitational direction and acceleration due to applied forces. In addition to, or instead of, an accelerometer, an electronic compass can be included to detect the spatial orientation of the electronic device relative to the earth's magnetic field. Similarly, one or more gyroscopes can be included to detect rotational orientation of the electronic device 100.

A gaze detector can be included with the one or more sensors 223 and can comprise sensors for detecting the user's gaze point. The gaze detector can include an iris scanner. The gaze detector can optionally include sensors for detecting the alignment of a user's head in three-dimensional space. Electronic signals can then be processed for computing the direction of user's gaze in three-dimensional space. The gaze detector can further be configured to detect a gaze cone corresponding to the detected gaze direction, which is a field of view within which the user may easily see without diverting their eyes or head from the detected gaze direction. The gaze detector can be configured to alternately estimate gaze direction by inputting images representing a photograph of a selected area near or around the eyes. It will be clear to those of ordinary skill in the art having the benefit of this disclosure that these techniques are explanatory only, as other modes of detecting gaze direction can be substituted in the gaze detector.

Other components 221 operable with the one or more processors 206 can include output components 220 such as video, audio, and/or mechanical outputs. For example, the output components 220 may include a video output component or auxiliary devices including a cathode ray tube, liquid crystal display, plasma display, incandescent light, fluorescent light, front or rear projection display, and light emitting diode indicator. Other examples of output components 220 include audio output components such as a loudspeaker disposed behind a speaker port or other alarms and/or buzzers and/or a mechanical output component such as vibrating or motion-based mechanisms.

The other components 221 can also include proximity sensors. The proximity sensors fall in to one of two camps: active proximity sensors and “passive” proximity sensors. Either the proximity detector components or the proximity sensor components can be generally used for gesture control and other user interface protocols, some examples of which will be described in more detail below.

Proximity sensor components are sometimes referred to as a “passive IR detectors” due to the fact that the person is the active transmitter. Accordingly, the proximity sensor component requires no transmitter since objects disposed external to the housing deliver emissions that are received by the infrared receiver. As no transmitter is required, each proximity sensor component can operate at a very low power level. Simulations show that a group of infrared signal receivers can operate with a total current drain of just a few microamps.

By contrast, proximity detector components include a signal emitter and a corresponding signal receiver. While each proximity detector component can be any one of various types of proximity sensors, such as but not limited to, capacitive, magnetic, inductive, optical/photoelectric, imager, laser, acoustic/sonic, radar-based, Doppler-based, thermal, and radiation-based proximity sensors, in one or more embodiments the proximity detector components comprise infrared transmitters and receivers.

The other components 221 can optionally include a barometer operable to sense changes in air pressure due to elevation changes or differing pressures of the electronic device 100. Where included, in one embodiment the barometer includes a cantilevered mechanism made from a piezoelectric material and disposed within a chamber. The cantilevered mechanism functions as a pressure sensitive valve, bending as the pressure differential between the chamber and the environment changes. Deflection of the cantilever ceases when the pressure differential between the chamber and the environment is zero. As the cantilevered material is piezoelectric, deflection of the material can be measured with an electrical current.

The other components 221 can also optionally include a light sensor that detects changes in optical intensity, color, light, or shadow in the environment of an electronic device. This can be used to make inferences about context such as weather or colors, walls, fields, and so forth, or other cues. An infrared sensor can be used in conjunction with, or in place of, the light sensor. The infrared sensor can be configured to detect thermal emissions from an environment about the electronic device 100. Similarly, a temperature sensor can be configured to monitor temperature about an electronic device. The other components 221 can also include a flash. The other components 221 can also include a fingerprint sensor or retina scanner.

In one or more embodiments, the one or more processors 206, optionally working in conjunction with the transaction manager 211, are configured to determine a probable failure of the digital wallet application 218 to complete an upcoming financial transaction 205 that has been identified by the one or more processors 206 due to one or more merchant or payment processor system malfunctions from data 226 retrieved with the communication device 208 across a network 228 from a remote electronic device 227. Techniques for doing so were described above with reference to FIG. 1. Others will be obvious to those of ordinary skill in the art having the benefit of this disclosure.

In one or more embodiments, when this occurs the one or more processors 206 cause the user interface 202 to present a potential payment failure mode notification 225 identifying a reason for the probable failure of the digital wallet application 218 to complete the upcoming financial transaction 205 due to one or more merchant or payment processor system malfunctions. In one or more embodiments, this potential payment failure mode notification 225 is presented prior to the upcoming financial transaction 205 identified by the one or more processors 206 occurring.

In one or more embodiments, the potential payment failure mode notification 225 instructs one or more alternate payment modes 224 for use while the probable failure of the digital wallet application 218 to complete the upcoming financial transaction 205 is occurring due to one or more merchant or payment processor system malfunctions. As noted above, the potential payment failure mode notification 225 can be presented when an audio output of the output components 220 delivers an audible alert as well.

Where the electronic device 100 is equipped with a location detector 229, in one or more embodiments the one or more processors 206 and/or transaction manager 211 is configured to cause the user interface 202 to present the potential payment failure mode notification 225 in response to the location detector 229 detecting the electronic device 100 exciting a dwelling of an authorized user of the electronic device 100. Advantageously, this results in the potential payment failure mode notification 225 being presented in a timely manner, namely, when an authorized user of the electronic device 100 is leaving their “home” location. Thus, in one or more embodiments a method in the electronic device 100 comprises detecting, by the location detector 229, the electronic device 100 exiting a dwelling of an authorized user of the electronic device 100, with the potential payment failure mode notification 225 being presented at this predetermined time.

In other embodiments, the one or more processors 206 and/or transaction manager 211 cause the potential payment failure mode notification 225 to be presented at another predetermined time during the day. Illustrating by example, in other embodiments the one or more processors 206 and/or the transaction manager 211 cause the predetermined time at which the potential payment failure mode notification 225 is presented to correspond with an alarm of an alarm application of the one or more applications 217. For instance, when an authorized user of the electronic device 100 desires the potential payment failure mode notification 225 to be presented at the start of the day, the one or more processors 206 and/or transaction manager 211 can present the same when the morning alarm rings. Other predetermined times at which the potential payment failure mode notification 225 can be presented will be obvious to those of ordinary skill in the art having the benefit of this disclosure.

In one or more embodiments, as was in the illustrative example described above with reference to FIG. 1, the potential payment failure mode notification 225 reminds the authorized user of the electronic device 100 to be sure to take at least one payment mode of the one or more payment modes accepted by the merchant along with them when going to make the financial transaction corresponding to the prospective financial transaction. In one or more embodiments, this at least one alternate payment mode suggestion omits use of the digital wallet application 218. Such was the case in the example described above with reference to FIG. 1 where Paul (907) took a wad of cash (911) to Buster's Chicken Shack (909).

Of course, these various operations can be used alone or in combination. Other operations suitable for inclusion in the abnormal mode of operation will be described below. Still others will be obvious to those of ordinary skill in the art having the benefit of this disclosure.

It is to be understood that FIG. 2 is provided for illustrative purposes only and for illustrating components of one electronic device 100 in accordance with embodiments of the disclosure and is not intended to be a complete schematic diagram of the various components required for an electronic device. Therefore, other electronic devices in accordance with embodiments of the disclosure may include various other components not shown in FIG. 2 or may include a combination of two or more components or a division of a particular component into two or more separate components, and still be within the scope of the present disclosure.

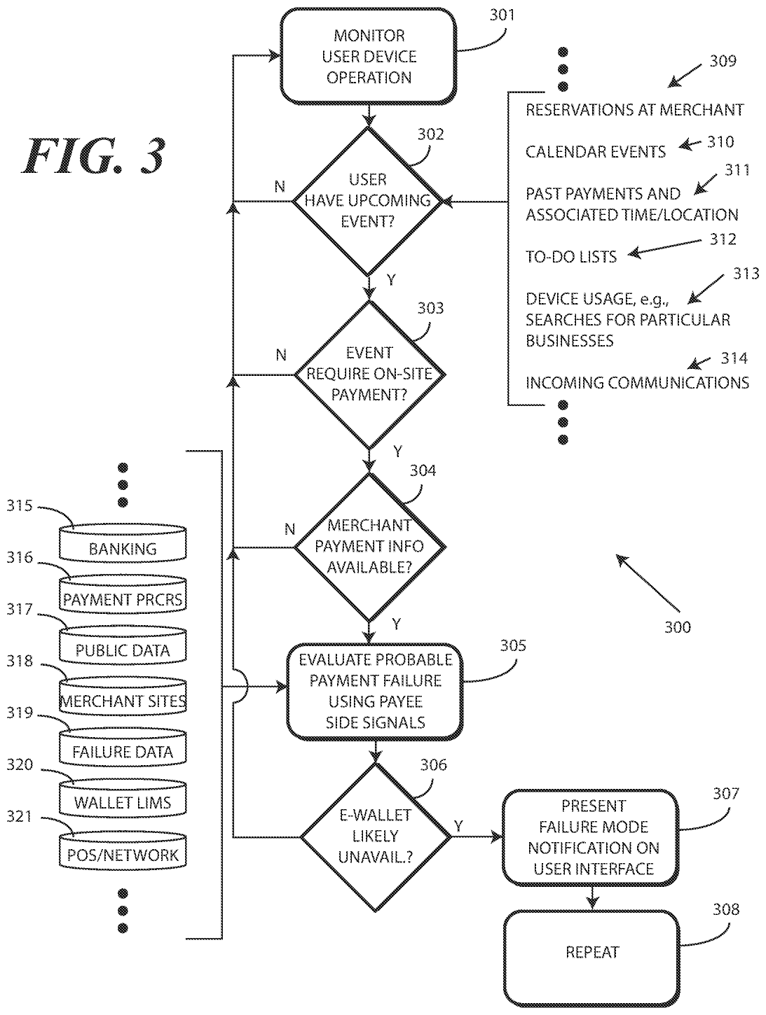

Turning now to FIG. 3, illustrated therein is one explanatory method 300 suitable for execution in an electronic device (100) in accordance with one or more embodiments of the disclosure. The method 300 of FIG. 3 detects a prospective financial transaction using a digital wallet application operable on one or more embodiments of the electronic device, identifies, from data retrieved with a communication device of the electronic device, one or more probable digital wallet application payment failure modes due to one or more merchant or payment processor system malfunctions, and in response to identifying at least one probable digital wallet application payment failure mode due to one or more merchant or payment processor system malfunctions, presents a potential payment failure mode notification on a user interface of the electronic device identifying the at least one probable digital wallet application payment failure mode due to one or more merchant or payment processor system malfunctions. This presentation of the potential payment failure mode notification can also be accompanied by an audible alert delivered by an audio output device in one or more embodiments.

Beginning at step 301, one or more processors of an electronic device monitor device operation. Decision 302 and decision 303 detect, collectively, an expected future financial transaction with a merchant requiring on-site payment. Decision 302 first determines whether a user of the electronic device has an upcoming event, while decision 303 determines whether the event corresponds to an expected future financial transaction, one example of which is a prospective financial transaction with a merchant, requiring on-site payment at the merchant.

Decision 302 can be made in a variety of ways. Illustrating by example, decision 302 can comprise querying a memory of the electronic device or a remote electronic device in communication with the electronic device, e.g., a “cloud” computing device, to determine whether there are any upcoming reservations 309 with a merchant that have been made electronically using the electronic device. In other embodiments, the detection occurring at decision 302 comprises querying, using one or more processors of the electronic device, a calendaring application 310 to detect a scheduled appointment stored in the calendaring application 310 that identifies the merchant.

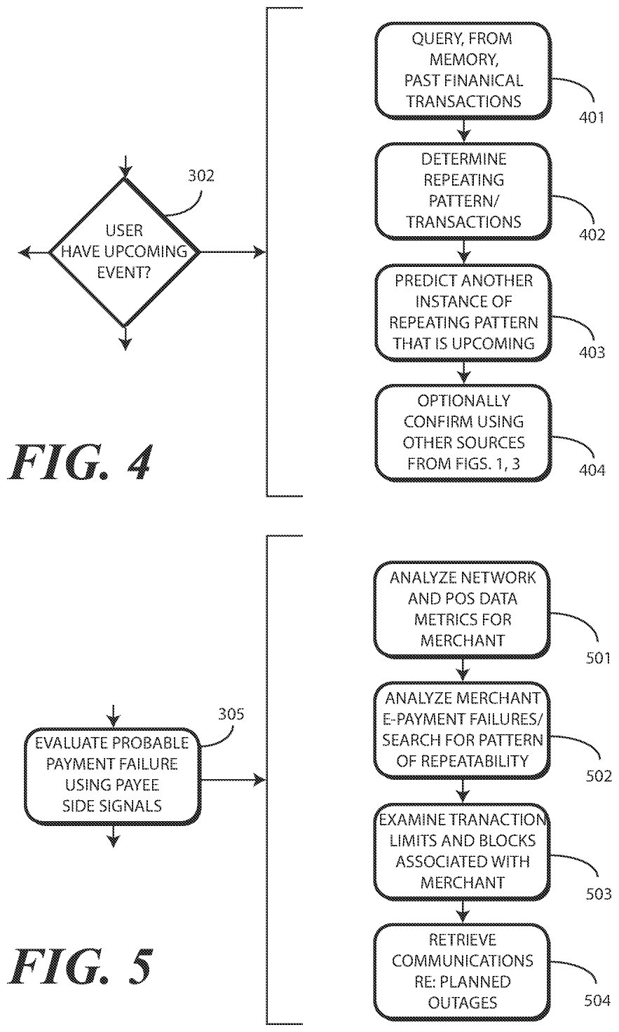

Turning briefly to FIG. 4, in still other embodiments decision 302 comprises querying, at step 401 from a memory of the electronic device or a remote electronic device in communication with the electronic device, past financial transactions made by an authorized user of the electronic device that are stored in the memory. At step 402, decision 302 comprises determining whether a repeating pattern in these financial transactions. From this repeating pattern, step 403 can predict another instance of the repeating pattern, with step 404 using the other sources of FIG. 3 to confirm any prediction of an expected future financial transaction.

Illustrating by example, if our friend from above, Paul, goes to eat at Buster's Chicken Shack every day at 10:15 AM after leaving his Sunday morning run, decision 302 may determine that there is an expected future financial transaction at Buster's Chicken Shack when the repeating pattern is detected and Paul and his electronic device are out on their run at 10:00 AM. Accordingly, an affirmative decision made at decision 302 can predict, at step 403, another instance of the repeating pattern as the expected future financial transaction. Turning now back to FIG. 3, past payments 311, which can include time and location metadata, can be used in a similar manner.

In still other embodiments decision 302 comprises querying, by one or more processors from a memory of the electronic device or a remote electronic device in communication with the electronic device, an electronically stored to-do list 312 to identify one or more to-do list items stored in the memory that reference a merchant. In still other embodiments, decision 302 comprises querying, by one or more processors of the electronic device or a remote electronic device in communication with the electronic device, an Internet search history 313 of a web browsing application stored in the memory to identify a search history entry identifying a merchant.

In still other embodiments, decision 302 can comprise extracting upcoming event information from incoming communications 314. Thus, decision 302 can comprise receiving, with a communication device by one or more processors of an electronic device, an electronic communication 314 identifying both a scheduled appointment and a merchant in one or more embodiments.

For instance, if Paul makes a reservation at Buster's Chicken Shack before going on the run, the maître d' may send an email saying, “Your Rendezvous with Severely Delicious Chicken Begins Tomorrow at 10:30 AM at Buster's Chicken Shack.” In one or more embodiments, decision 302 detects an expected future financial transaction by extracting the contextual information from such incoming communications 314.

Presuming an upcoming event is detected, decision 303 determines whether an on-site payment is likely to be required. For many situations, decision 303 can simply identify the merchant with which the upcoming event detected at decision 302 corresponds, as certain types of merchants generally always require on-site payment. Examples of such merchants include grocery stores, barber shops, restaurants, chicken shacks, bars, golf courses, and the like.

In other embodiments, indicia that an on-site payment is required can be determined by extracting such indicia from the sources from which the upcoming event is detected at decision 302. Illustrating by example, if the upcoming reservation at Buster's Chicken Shack is detected from incoming communications 314, the email message may also say, “the cost for the ‘full experience’ is $325.” These indicia could be extracted to determine that an on-site payment is required. Other techniques for determining at decision 303 whether the on-site payment is required will be obvious to those of ordinary skill in the art having the benefit of this disclosure.

Decision 304 then determines whether any merchant payment mode information is available. In one or more embodiments, this decision comprises fetching payee side signals from a remote electronic device across a network. Presuming that at least some merchant payment mode information is available, the method 300 moves to step 305. Otherwise, the method 300 returns to step 301.

At step 305, the method 300 retrieves, with a communication device of the electronic device, reasons indicating that completion of the expected future financial transaction using a digital wallet application operating on the one or more processors will be unsuccessful due to one or more merchant or payment processor system malfunctions. In one or more embodiments, step 305 comprises retrieving, with a communication device of an electronic device, these reasons due to one or more merchant or payment processor system malfunctions in the form of data obtained from a remote electronic device across a network.

In one or more embodiments, the remote electronic device from which the reasons indicating that completion of the expected future financial transaction using the digital wallet application operating on the one or more processors will be unsuccessful are obtained from a bank 315 associated with a merchant or other payee. The data retrieved from the bank 315 can include planned outages or maintenance of the electronic banking system allowing the merchant or payee to accept payments. In other embodiments, the remote electronic device is operated by a payment method purveyor 316 or payment mode processor, with the reasons indicating that completion of the expected future financial transaction using the digital wallet application operating on the one or more processors will be unsuccessful due to one or more merchant or payment processor system malfunctions being published only by the payment mode purveyor or the payment mode processor.

In still other embodiments, the remote electronic device from which the reasons indicating that completion of the expected future financial transaction using the digital wallet application operating on the one or more processors will be unsuccessful due to one or more merchant or payment processor system malfunctions are retrieved comprises a public server 317, one example of which is a web server operated by, or hosting a website 318 for, a merchant or payee.

A database of past payment failures 319 at a merchant or payee during a particular time period can be used to evaluate whether the completion of an expected future financial transaction will be unsuccessful due to one or more merchant or payment processor system malfunctions. If a merchant routinely has past payment failures 319 on Wednesdays, for example, this may be a clear indication that next Wednesday another failure of the ability to process financial transactions due to one or more merchant or payment processor system malfunctions will occur again.

Merchant or payee digital wallet application transaction limits 320 can also be used to determine whether the completion of an expected future financial transaction will be unsuccessful due to one or more merchant or payment processor system malfunctions. Such limits 320 can include the merchant or payee reaching a maximum digital wallet application amount for a day or other time period, which may result in them not being able to accept any additional amounts. Additionally, the limits 320 can be imposed by a bank for various reasons, examples of which include a lack of proper paperwork, documentation, expiration of the business account, or other reasons. Similarly, network coverage issues 321 at the merchant or payee point of sale location can cause the completion of an expected future financial transaction to be unsuccessful due to one or more merchant or payment processor system malfunctions as well.

While FIG. 3 illustrates many techniques for retrieving reasons indicating that completion of an expected future financial transaction using a digital wallet application will be unsuccessful due to one or more merchant or payment processor system malfunctions, but others will be obvious to those of ordinary skill in the art having the benefit of this disclosure. Illustrating by example, digital wallet application service providers can also provide data identifying reasons indicating that completion of the expected future financial transaction using the digital wallet application operating on the one or more processors will be unsuccessful as well. Similarly, hardware manufacturers, such as the manufacturer of the point of sale terminal used by a merchant or payee, can provide data comprising reasons indicating that completion of the expected future financial transaction using the digital wallet application operating on the one or more processors will be unsuccessful due to one or more merchant or payment processor system malfunctions. Similarly, credit card and electronic wallet card vendors can cause the reasons indicating that completion of the expected future financial transaction using the digital wallet application operating on the one or more processors will be unsuccessful due to one or more merchant or payment processor system malfunctions to be relayed to the electronic device as well.

Turning briefly to FIG. 5, illustrated therein are some ways in which step 305 can be performed. Others will be obvious to those of ordinary skill in the art having the benefit of this disclosure.

In one or more embodiments, step 305 comprises, at step 501, retrieving data from a remote electronic device across a network comprising one or more of a merchant or payment processor network failure or equipment failure. At step 502, the data used at step 305 can comprise a plurality of past financial transaction failures occurring at one or more of a merchant or payment processor system within a predefined time, and that define a repeating pattern of one or more repeating financial transaction failures due to one or more merchant or payment processor system malfunctions.

At step 503, the data used at step 305 can comprise obtaining data comprising one or more of a maximum financial transaction limit of a merchant or payment processor block causing a failure of the digital wallet application. Illustrating by example, the payee wallet may have reached maximum limit and cannot receive any additional amounts. Alternatively, the payee wallet may be blocked by bank for any number of reasons, examples of which include invalid paperwork, lack of documentation, expiration of the payee business account, and so forth. At step 504, the data can comprise information identifying planned—or even unplanned—outages of the payee point of sale system.

Turning now back to FIG. 3, from this information decision 306 determines whether the digital wallet application is likely to be unavailable to complete the expected future financial transaction due to one or more merchant or payment processor system malfunctions. Where it is, step 307 comprises presenting, by one or more processors on a user interface of the electronic device, a potential payment failure mode notification.

In one or more embodiments, the potential payment failure mode notification presented at step 307 identifies one or more alternate modes of payment that should be successful in completing the expected future financial transaction. Optionally, the potential payment failure mode notification presented at step 307 can further explain the reasons indicating that completion of the expected future financial transaction using the digital wallet application operating on the one or more processors will be unsuccessful due to one or more merchant or payment processor system malfunctions. Illustrating by example, in one or more embodiments the potential payment failure mode notification can identify the malfunctions of the merchant or payment processor. One example of such a potential payment failure mode notification was illustrated and described above with reference to FIG. 1. Others will be obvious to those of ordinary skill in the art having the benefit of this disclosure.

In one or more embodiments, this step 307 occurs prior to the expected future financial transaction predicted by decision 302 and decision 303 occurring. In one or more embodiments, the potential payment failure mode notification presented at step 307 comprises a reminder to take a physical payment mode along when heading to the merchant to engage in the financial transaction corresponding to the expected future financial transaction.

Embodiments of the disclosure contemplate that it can be advantageous to deliver the potential payment failure mode notification at predefined times. Accordingly, in one or more embodiments step 307 comprises presenting the potential payment failure mode notification at a predetermined time during the day. Examples of such predetermined times of day including the start of the day or when a user leaves home.

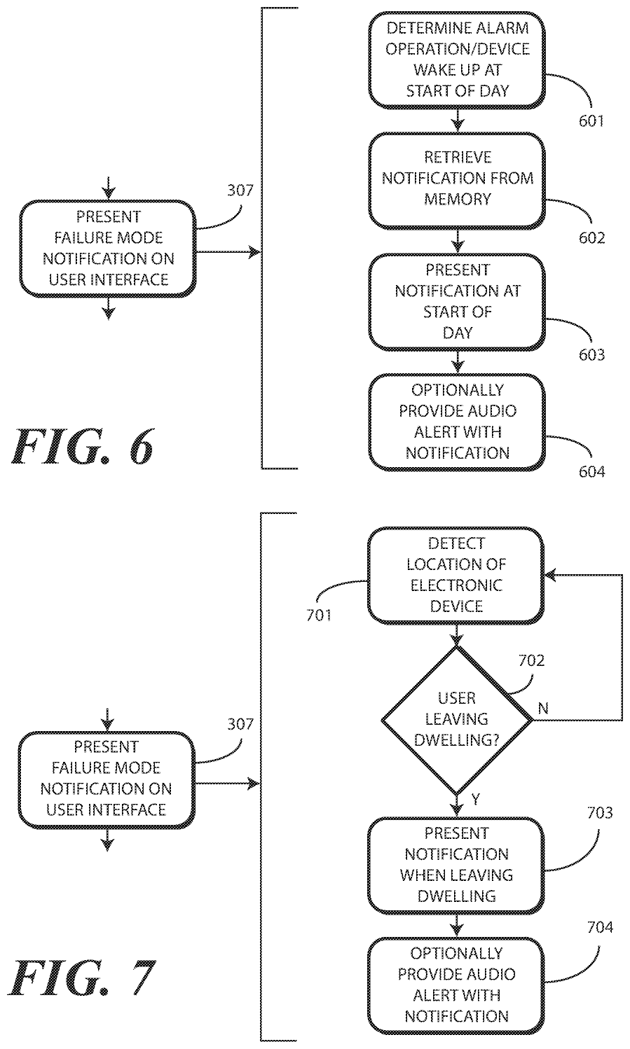

Turning briefly to FIG. 6, illustrated therein are one or more method steps indicating how the potential payment failure mode notification can be presented at step 307 and a predetermined time of day. In one or more embodiments the predetermined time corresponds with actuation of an alarm using an alarm application operating on one or more processors of an electronic device. Accordingly, step 601 can detect one or more of the actuation of the alarm, a user waking up, or the start of the day. Step 602 can retrieve a previously potential payment failure mode notification from memory. Step 603 can present the potential payment failure mode notification at the start of the day. Optional step 604 can deliver, with an audio output device by one or more processors of the electronic device, an audible alert concurrently with the presentation of the potential payment failure mode notification.

As an alternative to the start of the day, in other embodiments step 307 can comprise presenting the potential payment failure mode notification when a user leaves their dwelling. Turning now to FIG. 7, illustrated therein are one or more method steps illustrating how this can occur.

Beginning at step 701, in one or more embodiments a local display of the electronic device determines a location of the electronic device. At decision 702, the local display determines whether the electronic device is exiting the dwelling of an authorized user of the electronic device. Where it is, in one or more embodiments step 307 comprises presenting, at step 703, the potential payment failure mode notification when the electronic device exits the dwelling of the authorized user of the electronic device. Optional step 704 can deliver, with an audio output device by one or more processors of the electronic device, an audible alert concurrently with the presentation of the potential payment failure mode notification.

Turning now back to FIG. 3, at step 308 the method 300 can repeat each time a new prospective financial transaction or expected future financial transaction due to one or more merchant or payment processor system malfunctions is detected. As illustrated and described the method 300 of FIG. 3 detects, by one or more processors of the electronic device, an expected future financial transaction with a merchant requiring an on-site payment. The method 300 retrieves, with a communication device of the environment of the electronic device, reasons indicating that completion of the expected future financial transaction using a digital wallet application operating on the one or more processors of the electronic device will be unsuccessful due to one or more merchant or payment processor system malfunctions. In one or more embodiments, one or more processors of the electronic device present, on a user interface of the electronic device, a potential payment failure mode notification identifying one or more alternate modes of payment that will be successful in completing the expected future financial transaction and explaining the reasons indicating that completion of the expected future financial transaction using the digital wallet application operating on the one or more will be unsuccessful due to the one or more merchant or payment processor system malfunctions.

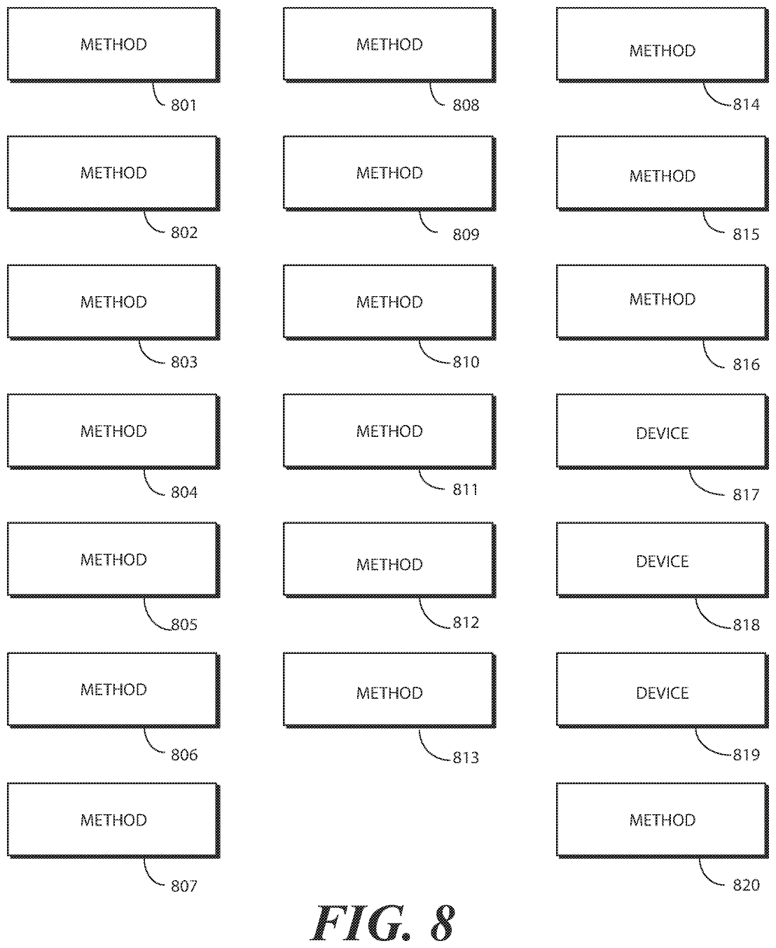

Turning now to FIG. 8, illustrated therein are various embodiments of the disclosure. The embodiments of FIG. 8 are shown as labeled boxes in FIG. 8 due to the fact that the individual components of these embodiments have been illustrated in detail in FIGS. 1-7, which precede FIG. 8. Accordingly, since these items have previously been illustrated and described, their repeated illustration is no longer essential for a proper understanding of these embodiments. Thus, the embodiments are shown as labeled boxes.

At 801, a method in an electronic device comprises detecting, with one or more processors of the electronic device, a prospective financial transaction using a digital wallet application operable on the one or more processors of the electronic device. At 801, the method comprises identifying, with the one or more processors from data retrieved with a communication device of the electronic device, one or more probable digital wallet application payment failure modes due to one or more merchant or payment processor system malfunctions. At 801, in response to identifying at least one probable digital wallet application payment failure mode due to one or more merchant or payment processor system malfunctions, the method comprises presenting, by the one or more processors on a user interface of the electronic device, a potential payment failure mode notification identifying the one or more probable digital wallet application payment failure modes.

At 802, the potential payment failure mode notification of 801 comprises at least one alternate payment mode suggestion. At 803, the at least one alternate payment mode suggestion of 802 suggests a payment mode that omits using the digital wallet application. At 804, the potential payment failure mode notification of 802 identifies the one or more merchant or payment processors system malfunctions.

At 805, the detecting the prospective financial transaction using the digital wallet application of 801 comprises querying, by the one or more processors, a calendaring application to detect a scheduled appointment stored in the calendaring application that identifies a merchant. At 806, the detecting the prospective financial transaction using the digital wallet application of 801 comprises receiving, with the communication device by the one or more processors, an electronic communication identifying both a scheduled appointment and a merchant.

At 807, the detecting the prospective financial transaction using the digital wallet application at 801 comprises querying, from a memory of the electronic device by the one or more processors, past financial transactions made by an authorized user of the electronic device that are stored in the memory. At 807, the detecting comprises determining, by the one or more processors, a repeating pattern of one or more repeating financial transactions and predicting, by the one or more processors, another instance of the repeating pattern as the prospective financial transaction.

At 808, the detecting the prospective financial transaction using the digital wallet application of 801 comprises querying, by the one or more processors form a memory of the electronic device, an electronically stored to-do list to identify one or more to-do items stored in the memory that reference a merchant. At 809, the detecting the prospective financial transaction using the digital wallet application of 801 comprises querying, by the one or more processors from a memory of the electronic device, an Internet search history of a web browsing application stored in the memory to identify a search history entry identifying a merchant.

At 810, the data of 801 retrieved with the communication device comprises one or more alert messages from one or more payment method purveyors or payment mode processors indicating that one or more merchant or payment processors systems will be unavailable. At 811, the data of 801 retrieved with the communication device comprises a plurality of past financial transaction failures occurring at one or more merchant or payment processor systems within a predefined time.

At 812, the data of 801 retrieved with the communication device comprises one or more of a maximum financial transaction limit or a block applied to a merchant or payment processor system. At 813, the data of 801 retrieved with the communication device comprises one or more of a merchant or payment processor network failure or equipment failure.

At 814, the presenting the potential payment failure mode notification of 802 occurs at a predetermined time during the day. At 815, the predetermined time of 814 corresponds with actuation, by the one or more processors, of an alarm using an alarm application operating on the one or more processors.

At 816, the method of 814 further comprises detecting, by a location detector, the electronic device exiting a dwelling of an authorized user of the electronic device. At 816, the predetermined time during the day occurs when the electronic device exits the dwelling of the authorized user of the electronic device.

At 817, an electronic device comprises a user interface, a communication device, and one or more processors operable with the user interface and communication device and operating a digital wallet application. At 817, the one or more processors are configured to determine a probable failure of the digital wallet application to complete upcoming financial transactions due to one or more merchant or payment processor system malfunctions and cause the user interface to present a potential payment failure mode notification identifying the one or more merchant or payment processor system malfunctions prior to the upcoming financial transactions occurring.

At 818, the potential payment failure mode notification of 817 instructs one or more alternative payment modes for use while the probable failure of the digital wallet application to complete the upcoming financial transactions is occurring. At 819, the potential payment failure mode notification of 818 comprises an audible alert.

At 820, a method in an electronic device comprises detecting, by one or more processors, an expected future financial transaction with a merchant requiring on-site payment. At 820, the method comprises retrieving, with a communication device of the electronic device, reasons indicating that completion of the expected future financial transaction using a digital wallet application operating on the one or more processors will be unsuccessful due to one or more merchant or payment processor system malfunctions. At 820, the method comprises presenting, by the one or more processors on a user interface of the electronic device, a potential payment failure mode notification identifying one or more alternate modes of payment that will be successful in completing the expected future financial transaction and explaining the reasons indicating that completion of the expected future financial transaction using the digital wallet application operating on the one or more processors will be unsuccessful due to one or more merchant or payment processor system malfunctions.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

What is claimed is:

1. A method in an electronic device, the method comprising:
detecting, with one or more processors of the electronic device, a prospective financial transaction using a digital wallet application operable on the one or more processors of the electronic device;
identifying, with the one or more processors from data retrieved with a communication device of the electronic device, one or more probable digital wallet application payment failure modes due to one or more merchant or payment processor system malfunctions; and
in response to identifying at least one probable digital wallet application payment failure mode due to the one or more merchant or payment processor system malfunctions, presenting, by the one or more processors on a user interface of the electronic device, a potential payment failure mode notification identifying the one or more probable digital wallet application payment failure modes.

2. The method of claim 1, wherein the potential payment failure mode notification comprises at least one alternate payment mode suggestion.

3. The method of claim 2, wherein the at least one alternate payment mode suggestion suggests a payment mode that omits using the digital wallet application.

4. The method of claim 2, wherein the potential payment failure mode notification identifies the one or more merchant or payment processor system malfunctions.

5. The method of claim 1, wherein the detecting the prospective financial transaction using the digital wallet application comprises querying, by the one or more processors, a calendaring application to detect a scheduled appointment stored in the calendaring application that identifies a merchant.

6. The method of claim 1, wherein the detecting the prospective financial transaction using the digital wallet application comprises receiving, with the communication device by the one or more processors, an electronic communication identifying both a scheduled appointment and a merchant.

7. The method of claim 1, wherein the detecting the prospective financial transaction using the digital wallet application comprises:
querying, from a memory of the electronic device by the one or more processors, past financial transactions made by an authorized user of the electronic device that are stored in the memory;
determining, by the one or more processors, a repeating pattern of one or more repeating financial transactions; and
predicting, by the one or more processors, another instance of the repeating pattern as the prospective financial transaction.

8. The method of claim 1, wherein the detecting the prospective financial transaction using the digital wallet application comprises querying, by the one or more processors form a memory of the electronic device, an electronically stored to-do list to identify one or more to-do items stored in the memory that reference a merchant.

9. The method of claim 1, wherein the detecting the prospective financial transaction using the digital wallet application comprises querying, by the one or more processors from a memory of the electronic device, an Internet search history of a web browsing application stored in the memory to identify a search history entry identifying a merchant.

10. The method of claim 1, wherein the data retrieved with the communication device comprises one or more alert messages from one or more payment method purveyors or payment mode processors indicating that one or more merchant or payment processor systems will be unavailable.

11. The method of claim 1, wherein the data retrieved with the communication device comprises a plurality of past financial transaction failures occurring at one or more merchant or payment processor systems within a predefined time.

12. The method of claim 1, wherein the data retrieved with the communication device comprises one or more of a maximum financial transaction limit or a block applied to a merchant or payment processor system.

13. The method of claim 1, wherein the data retrieved with the communication device comprises one or more of a merchant or payment processor network failure or equipment failure.

14. The method of claim 2, wherein the presenting the potential payment failure mode notification occurs at a predetermined time during the day.

15. The method of claim 14, wherein the predetermined time corresponds with actuation, by the one or more processors, of an alarm using an alarm application operating on the one or more processors.

16. The method of claim 14, further comprising:
detecting, by a location detector, the electronic device exiting a dwelling of an authorized user of the electronic device;
wherein the predetermined time during the day occurs when the electronic device exits the dwelling of the authorized user of the electronic device.

17. An electronic device, comprising:
a user interface;
a communication device; and
one or more processors operable with the user interface and communication device and operating a digital wallet application;
wherein the one or more processors are configured to determine a probable failure of the digital wallet application to complete upcoming financial transactions due to one or more merchant or payment processor system malfunctions and cause the user interface to present a potential payment failure mode notification identifying the one or more merchant or payment processor system malfunctions prior to the upcoming financial transactions occurring.

18. The electronic device of claim 17, wherein the potential payment failure mode notification instructs one or more alternative payment modes for use while the probable failure of the digital wallet application to complete the upcoming financial transactions is occurring.

19. The electronic device of claim 18, wherein the potential payment failure mode notification comprises an audible alert.

20. A method in an electronic device, the method comprising:
detecting, by one or more processors, an expected future financial transaction with a merchant requiring on-site payment;
retrieving, with a communication device of the electronic device, reasons indicating that completion of the expected future financial transaction using a digital wallet application operating on the one or more processors will be unsuccessful due to one or more merchant or payment processor system malfunctions; and
presenting, by the one or more processors on a user interface of the electronic device, a potential payment failure mode notification identifying one or more alternate modes of payment that will be successful in completing the expected future financial transaction and explaining the reasons indicating that completion of the expected future financial transaction using the digital wallet application operating on the one or more will be unsuccessful due to the one or more merchant or payment processor system malfunctions.
